(19) United States
(12) Patent Application Publication
(10) Pub. No.: US 2016/0306907 A1
(43) Pub. Date: Oct. 20, 2016

(54) NUMERICAL METHOD FOR SOLVING THE TWO-DIMENSIONAL RIEMANN PROBLEM TO SIMULATE INVISCID SUBSONIC FLOWS

(71) Applicant: Ming LU, Tianjin (CN)

(72) Inventor: Ming LU, Tianjin (CN)

(21) Appl. No.: 13/985,042

(22) PCT Filed: Sep. 18, 2012
(86) PCT No.: PCT/CN2012/081518

§ 371 Date: Aug. 13, 2013

(51) Int. Cl. G06F 17/50; G06F 17/16

(52) U.S. Cl. CPC G06F 17/5018; G06F 17/16

(57) ABSTRACT

This invention relates to the numerical method for simulating inviscid subsonic flows by solving two-dimensional Riemann problem. this invention transforms the Euler equations into a stream-function plane and solve the equations under an uniform computing grid by solving the two-dimensional Riemann problem across streamlines and the two-dimensional Riemann problem along streamlines.

### FIELD OF THE INVENTION

This invention, belonging to computational fluid dynamics (CFD) domain, relates to a numerical method for solving two-dimensional Riemann problem when solving the fluid flow governing equation. This method is implemented using computer language codes and the codes are run on computer to simulate inviscid subsonic flows.

### BACKGROUND OF THE INVENTION

The Riemann Problem originally was studied as a physical phenomenon of gas flows in a one-dimensional tube. In the tube, the compressed gas produces shock, across which the velocity, density, pressure, and entropy are discontinuous. Georg Friedrich Bernhard Riemann (1826˜1866) had extensively studied this flow phenomena, and proposed the method to solve an initial value problem for the one-dimensional Euler equations, which is also called the Riemann problem. The FIG. 1(a) is the physical model of the Riemann problem. In a one-dimensional tube (1), there are two physical states, left state Q_{L}=[ρ_{L}, u_{L}, p_{L}] and right state Q_{R}=[ρ_{R}, u_{R}, p_{R}] divided by a diaphragm (2) on the center. ρ, u, p present the density, velocity and pressure; the subscript L and R for the left state and right state respectively. If there exist difference between the left and right states, rupture of the diaphragm generates a nearly centered time-dependent wave system. Based on this physical model, Riemann built the analytical solution for the one-dimensional Euler equations for compressible inviscid flows.

The FIG. 1 (b) presents the definition of the Riemann problem and the application to solving the one-dimensional Euler equations. x-direction is the flowing direction and t direction is the time. At the rupture moment of the diaphragm, the zero time, the generated wave system typically consists of a expansion wave, a shock wave at the left or the right. between the left and right waves, the star state, marked with the subscript *, is divided by a middle wave into the star left Q_{L*}=[ρ_{L*}, u_{*}, p_{*}] and star right Q_{R*}=[ρ_{R*}, u_{*}, p_{*}]. Riemann obtained the four kinds analytical solutions of the Euler equations and their judgment conditions at this situation. This work laid the foundations of the theory of the hyperbolic conservation law for the partial differential equations and a class of characteristics-based numerical method for fluid flow governing equations.

The main task for computational fluid dynamics (CFD) is to construct numerical method to solve the governing equations of fluid flows, such as the Euler equations for inviscid flows, in which the spatial discretization for the convective flux term is the most difficult. Most numerical computation is implemented in the Cartesian coordinator system, which needs to generate the computing grid according to the computational domain in advance. The computing grid forms the computing cells. Across the cell interfaces of the computing cell, the convective flux exists since the fluid particles passing over. It is this convective flux that causes severe numerical diffusion in the numerical solutions because the numerical diffusion is directly associated with the error resulting from numerically approximating this term. Since the last century, the primary CFD efforts of algorithm researchers had been concentrated on developing more robust, accurate, and efficient ways to reduce the diffusion. In particular, a class of upwind methods had a great deal of success in solving fluid flows governing equations, because the upwind methods reasonably represent the characteristics of the convective flux.

Among them, typically, the Godunov method [1], based on solving the Riemann problem on the cell interfaces, gives the most accurate results. Until publicly known relative technology, for the multi-dimensional computation, such as two-dimension, it needs to solve the Riemann problem alternatively along the different coordinator directions. However, like shown in the FIG. 2 (a), the interface AB generally is not perpendicular to the velocity vector V, so that it needs to project two velocity components u, v of V in the Cartesian coordinator system (x-y) into the (ξ-η) coordinator system, which is orthogonal to AB and produce u1, u2 and v1, v2, like shown in the FIG. 2 (b). In the ξ-direction, the summation of u1, v1 is considered as the left state in the Riemann problem; while that of u2, v2 is done as constant value even across shock. This scheme is obviously violates the entropy increase principle and introduces error in numerical solution. The stronger the shock is, the bigger the error is.

To minimize this error, this invention presents a numerical solver of the two-dimensional Riemann problem when solving the two-dimensional Euler equation to simulate inviscid subsonic flows.

### DETAILED DESCRIPTION OF PARTICULAR EMBODIMENTS OF THE INVENTION

This invention stars from the time-dependent Euler equations in differential conservation form in the Eulerian plane for two-dimensional unsteady inviscid compressible flows

$$\frac{\partial f}{\partial t} + \frac{\partial F}{\partial x} + \frac{\partial G}{\partial y} = 0 , \qquad ( 1 )$$

where f is the conservation variables vector; F, G are the convection fluxes in the x, y direction in the Cartesian coordinator system. In detail,

$$f = [ \begin{matrix}ρ \\ ρ u \\ ρ v \\ ρ E\end{matrix} ] , \\ F = [ \begin{matrix}ρ u \\ ρ {u}^{2} + p \\ ρ uv \\ ( ρ E + p ) u\end{matrix} ] , \\ G = [ \begin{matrix}ρ v \\ ρ uv \\ ρ {v}^{2} + p \\ ( ρ E + p ) v\end{matrix} ] , \qquad ( 2 )$$

where the variables t, u, v, ρ and p are respectively the time, components of flow velocity V in the x, y direction in the Cartesian coordinator system, fluid density and pressure. The total energy E and enthalpy H are

$$E = \frac{1}{2} ( {u}^{2} + {v}^{2} ) + \frac{1}{γ - 1} \frac{p}{ρ} , \\ H = E + \frac{p}{ρ} = \frac{{u}^{2} + {v}^{2}}{2} + \frac{γ}{γ - 1} \frac{r}{ρ} , \qquad ( 3 )$$

In above equation γ is the specific heat ratio.

This invention creates a numerical solver of the two-dimensional Riemann problem for calculating the convection fluxes F and G when solving the equation (1).

### Construction of the Present Numerical Solver

According to the FIG. 3, there is a particle A, with a velocity vector V, on a streamline in the x-y plane, the Cartesian coordinator system. Firstly, another coordinator system, λ-ξ plane, named as the streamline plane, is built, where the coordinator λ, parallel the V direction, presents the particle traveling distance; while ξ, perpendicular the V dose the stream-function. In the λ-ξ plane, the time variable τ has the same dimension as time term t. The Jacobian matrix of the transformation from coordinates (t, x, y) to (τ, λ, ξ) can be written as

$$J = \frac{\partial ( t , x , y )}{\partial ( τ , λ , ξ )} = [ \begin{matrix}1 & 0 & 0 \\ u & cos θ & U \\ v & sin θ & V\end{matrix} ] , \qquad ( 4 )$$

and its determinant J becomes

$$J = \vert \begin{matrix}cos θ & U \\ sin θ & V\end{matrix} \vert = V cos θ - U sin θ , \qquad ( 5 )$$

where θ is the flow direction angle; U, V, the stream-function geometry state variables with the dimension [m²s·kg⁻¹], are defined as

$$U = \frac{\partial x}{\partial ξ} , \\ V = \frac{\partial y}{\partial ξ} . \qquad ( 6 )$$

Finally, the two-dimensional time-dependent Euler equations (1) have been transformed into the ones in the stream-function plane

$$\frac{\partial {f}_{S}}{\partial τ} + \frac{\partial {F}_{S}}{\partial λ} + \frac{\partial {G}_{S}}{\partial ξ} = 0 , \qquad ( 7 )$$

where f_{S}, F_{S} and G_{S} have the same definitions as f, F and G in (2) but in the stream-function plane with the subscript S. in detailed,

$${f}_{S} = [ \begin{matrix}ρ J \\ ρ Ju \\ ρ Jv \\ ρ JE \\ U \\ V\end{matrix} ] , {F}_{S} = [ \begin{matrix}0 \\ Vp \\ - Up \\ 0 \\ 0 \\ 0\end{matrix} ] , {G}_{S} = [ \begin{matrix}0 \\ - pS \\ pT \\ 0 \\ - u \\ - v\end{matrix} ] , \qquad ( 8 )$$

with the notations of J in (5) and

$$\begin{matrix}θ = {tg}^{- 1} ( \frac{v}{u} ) , & ( 9 ) \\ S = sin θ , & ( 10 ) \\ T = cos θ . & ( 11 )\end{matrix}$$

The equations (7) are called the two-dimensional time-dependent Euler equations in the stream-function formulation. In the equations (8), where the first and fourth elements in the F_{S} and G_{S} are zero, which means that for the computing grid in the stream-function plane there apparently are no convection flux going through the cell interfaces for the continuity and energy equations in ξ-direction, which mostly reduce the error from the approximation to convection flux. Comparing with the equations (1), the equations (7) have the more simple formulation.

Following the publicly known characteristics analysis method for partial difference equation (PDE), we obtain the characteristic curve equations for the equations (7). They are

dλ/dτ=±(a/J)\sqrt{U²+V²};dλ/dτ=0, (10)

in the λ-direction, and

dξ/dτ=±a/J;dξ/dτ=0, (11)

in the ξ-direction. In above equations, a is the speed of sound.

The characteristics equations along the characteristic curve (10-11) respectively are

$$\begin{matrix}dp \pm ρ a \frac{\sqrt{{U}^{2} + {V}^{2}}}{V} du = 0 ; & ( 19 ) \\ dp \pm ρ a \frac{\sqrt{{u}^{2} + {v}^{2}}}{u} dv = 0. & ( 20 )\end{matrix}$$

In addition, the definition (6) is approximated by,

$$U = \frac{Δ x}{Δξ} , V = \frac{Δ y}{Δ ξ} . \qquad ( 21 )$$

Bring (21) into (19) and consider that the equations (7) are with the rotational invariance property, the characteristics equation (19) is rewritten as

$$dp \pm ρ a \frac{\sqrt{{u}^{2} + {v}^{2}}}{v} du = 0. \qquad ( 22 )$$

On the stream-function plane in this invention, the ξ-direction is perpendicular to the streamline. The Riemann problem across the ξ-direction is called the Riemann problem across streamlines. Rewrite (7) only in ξ-direction,

$$\frac{\partial f}{\partial τ} + \frac{\partial G ( f )}{\partial ξ} = 0 , f = \{ \begin{matrix}{f}_{L} , & ξ < 0 , \\ {f}_{R} , & ξ > 0 ,\end{matrix} \qquad ( 23 )$$

where f_{L} and f_{R} are the conservation variables at the left and right state of the cell interface respectively. The FIG. 4 presents the definition of the two-dimensional Riemann problem across streamlines, which is different to the definition in the FIG. 1, since the left and right states and left and right middle states all include the two velocity components, u and v, which both are across the shocks, expansion waves and middle waves expressed by the equations (11). In the Riemann problem, operation with the two velocity component at the same time will reduce the error produced when operation with one-dimensional Riemann problem in two coordinator directions alternatively.

The task is to find the values of the primitive variables p, ρ, u, v from f to obtain G at cell interfaces. The primitive variables are the variables in the middle region in the Riemann problem. a two-dimensional Riemann solver is built as the following procedure.

Connecting the left and right states to the middle state by integrating along the characteristics equations (20), then we have

$$\begin{matrix}\{ \begin{matrix}{p}_{*} + {C}_{L} \cdot f ( {u}_{*} , {v}_{*} ) = {p}_{L} + {C}_{L} \cdot f ( {u}_{L} , {v}_{L} ) , \\ {p}_{*} - {C}_{R} \cdot f ( {u}_{*} , {v}_{*} ) = {p}_{R} - {C}_{R} \cdot f ( {u}_{R} , {v}_{R} ) , ( 25 ) \\ {ρ}_{* L} + f ( {u}_{*} , {v}_{*} ) ( {ρ}_{L} \text{/} {a}_{L} ) = {ρ}_{L} + f ( {u}_{L} , {v}_{L} ) ( {ρ}_{L} \text{/} {a}_{L} ) , ( 26 ) \\ {ρ}_{* R} + f ( {u}_{*} , {v}_{*} ) ( {ρ}_{R} \text{/} {a}_{R} ) = {ρ}_{R} - f ( {u}_{R} , {v}_{R} ) ( {ρ}_{R} \text{/} {a}_{R} ) , ( 27 )\end{matrix} \\ where {C}_{L} = {ρ}_{L} {a}_{L} ; {C}_{R} = {ρ}_{R} {a}_{R} ; and & ( 24 ) \\ f ( u , v ) = \frac{1}{2} \frac{v \sqrt{{u}^{2} + {v}^{2}}}{u} + \frac{1}{2} u ln ( v + \sqrt{{u}^{2} + {v}^{2}} ) . & ( 28 )\end{matrix}$$

f(u, v) is called the combination function, which can be considered as the combination of the velocity component (u, v) in the stream-function plane and have the same role as the velocity term with dimension [m/s]. The (28) has its polar formulation as

$${f}_{Δ} = ( V , θ ) = \frac{V}{2} ( tg θ + cos θln ( ( 1 + sin θ ) ) + \frac{cos θ}{2} V ln V , \qquad ( 29 )$$

with V=\sqrt{u²+v²}, u=V cos θ, v=V sin θ The solutions of (24-27) give the primitive variables in the middle state. They are

$$\{ \begin{matrix}{p}_{*} = \frac{{C}_{R} {p}_{L} + {C}_{L} {p}_{R} + {C}_{L} {C}_{R} ⌊ f ( {u}_{L} , {v}_{L} ) - f ( {u}_{R} , {v}_{R} ) ⌋}{{C}_{L} + {C}_{R}} , \\ f ( {u}_{*} , {v}_{*} ) = \frac{{C}_{L} \cdot f ( {u}_{L} , {v}_{L} ) + {C}_{R} \cdot f ( {u}_{R} , {v}_{R} ) + [ {p}_{L} - {p}_{R} ]}{{C}_{L} + {C}_{R}} , ( 31 ) \\ {ρ}_{* L} = {ρ}_{L} + ( f ( {u}_{L} , {v}_{L} ) - f ( {u}_{*} , {v}_{*} ) ) ( {ρ}_{L} \text{/} {a}_{L} ) , ( 32 ) \\ {ρ}_{* R} = {ρ}_{R} + ( f ( {u}_{*} , {v}_{*} ) - f ( {u}_{R} , {v}_{R} ) ) ( {ρ}_{R} \text{/} {a}_{R} ) . ( 33 )\end{matrix} \qquad ( 30 )$$

To find the velocity components u*, v* either in left or right middle state, the equation (31) need to be solved. Firstly, one can rewrite (31) as

F(u_{*},v_{*})=f(u_{*},v_{*})−B=0, (34)

with the known conditions in left and right states,

$$B = \frac{{C}_{L} \cdot f ( {u}_{L} , {v}_{L} ) + {C}_{R} \cdot f ( {u}_{R} , {v}_{R} ) + [ {p}_{L} - {p}_{R} ]}{{C}_{L} + {C}_{R}} . \qquad ( 35 )$$

The combination function (28) can be further modified with definition

tgθ_{*}=ε, (36)

where θ_{*} is the flow angle either in left or right middle state, then

$${u}_{*} = {V}_{*} cos {θ}_{*} = \frac{{V}_{*}}{\sqrt{1 + {ɛ}^{2}}} ; \\ {v}_{*} = {V}_{*} sin {θ}_{*} = \frac{ɛ {V}_{*}}{\sqrt{1 + {ɛ}^{2}}} , \qquad ( 37 )$$

where V_{*} is the velocity magnitude either in the left or right middle state. Further, the equation (34) can be finalized as a function of c

$$F ( ɛ ) = \frac{{V}_{*}}{2} ( ɛ + \frac{ln {V}_{*} + ln ( \sqrt{1 + {ɛ}^{2}} + ɛ ) - ln \sqrt{1 + {ɛ}^{2}}}{\sqrt{1 + {ɛ}^{2}}} ) - B = 0. \qquad ( 38 )$$

The work needs to do is numerically to solve the equation F(ε)=0 with a given velocity V_{*} to find ε for θ_{*}. The equation (38) does have the differentiability and its first-order derivative is

$${F}^{′} ( ɛ ) = \frac{{V}_{*}}{2} ( \frac{\begin{matrix}( 2 + {ɛ}^{2} ) \sqrt{1 + {ɛ}^{2}} - ɛ - \\ ɛ ( ln {V}_{*} + ln ( \sqrt{1 + {ɛ}^{2}} + ɛ ) - ln \sqrt{1 + {ɛ}^{2}} )\end{matrix}}{{( 1 + {ɛ}^{2} )}^{3 / 2}} ) . \qquad ( 39 )$$

Numerical experiments show that for the non-dimensional velocity V_{*}≦5 (subsonic flows) and ε∈[−1,1], F′(ε)>0, which means that the function F(ε) is monotone within this domain; in the mean time, F(−ε)·F(ε)<0, so that the Newton-Raphson iteration as a root-finding algorithm is a good way to find the roots for the equation (38) with a given V_{*}.

To find the value of K, the non-linear waves (shear, shock and expansion waves) in Riemann problem have to be recovered with the approximate values of p_{*}, ρ_{*L}, ρ_{*R}. In this invention, the following relations are considered:

(1) Rankine-Hugoniot Relations Across Shocks

If a shock wave appears between one state (say left) and the corresponding middle state, the Rankine-Hugoniot relations can be used to the left state and middle state across this shock. They are,

$$\{ \begin{matrix}{μ}_{s} ( {ρ}_{L} {J}_{L} - {ρ}_{* L} {J}_{* L} ) = 0 , \\ {μ}_{s} ( {ρ}_{L} {J}_{L} {E}_{L} - {ρ}_{* L} {J}_{* L} {E}_{* L} ) = 0 , ( 41 )\end{matrix} \qquad ( 40 )$$

where μₛ is the shock wave speed, J_{*L} and E_{*L} are J (transformation Jacobian) and E (total energy) in the middle state respectively. From (40) and (41), one receive that

$$\begin{matrix}{V}_{* L} = \sqrt{{V}_{L} + \frac{1}{γ - 1} ( \frac{{p}_{L}}{{ρ}_{L}} - \frac{{p}_{*}}{{ρ}_{* L}} )} \\ and & ( 42 ) \\ {V}_{* R} = \sqrt{{V}_{R} + \frac{1}{γ - 1} ( \frac{{p}_{R}}{{ρ}_{R}} - \frac{{p}_{*}}{{ρ}_{* R}} )} ∘ & ( 43 )\end{matrix}$$

Velocity absolute value V_{*L} or V_{*R} can be substituted into (38) to receive θ_{*L} or θ_{*R}.

(2) Enthalpy Constants Across Expansion Waves

If an expansion wave appears between one state (say left) and the corresponding middle state, the connection between the two states can be found by considering the enthalpy constant across the waves. Ones have

$${H}_{L} = \frac{1}{2} {V}_{L} + \frac{γ}{γ - 1} \frac{{p}_{L}}{{ρ}_{L}} = \frac{1}{2} {V}_{* L} + \frac{γ}{γ - 1} \frac{{p}_{*}}{{ρ}_{* L}} = {H}_{* L} , \qquad ( 44 )$$

from which the velocity magnitude can be found as

$$\begin{matrix}{V}_{* L} = \sqrt{2 {H}_{L} - \frac{2 γ}{γ - 1} \frac{{p}_{*}}{{ρ}_{* L}}} & ( 45 ) \\ and \\ {V}_{* R} = \sqrt{2 {H}_{R} - \frac{2 γ}{γ - 1} \frac{{p}_{*}}{{ρ}_{* R}}} . & ( 46 )\end{matrix}$$

The selection of the non-linear waves is based on the wave-type conditions, in which the values of pressure in left, right and middle states are used to judge what non-linear wave could appearing in the Riemann problem. Assuming

pₘᵢₙ=min(p_{L},p_{R}); (47)

pₘₐₓ=max(p_{L},p_{R}), (48)

which, as well as p_{*}, form the following wave-type choosing conditions:
(1) if pₘᵢₙ<p_{*}<Pₘₐₓ, which means in the Riemann problem one shock wave in the state with pₘᵢₙ and one expansion wave in the state with max Pₘₐₓ.
(2) if p_{*}≧pₘₐₓ, which means there are two shock waves;
(3) if p_{*}≦pₘᵢₙ, which means there are two expansion waves.

After θ_{*} is obtained, we can find G_{L} according to (9) with u_{*L}, v_{*L} or u_{*R}, v_{*R} from (36), as well as p_{*}. At the same time, the updated values can be found from the discretized equation (23),

$${f}_{i , j}^{n + 1 / 2} = {f}_{i , j}^{n} - \frac{Δτ}{Δξ} [ G ( {f}_{i , j + 1 / 2}^{n} ) - G ( {f}_{i , j - 1 / 2}^{n} ) ] , \qquad ( 49 )$$

where, i, j are the index of computing cell in λ and ξ direction, n is the time step. Meanwhile, the stream-function geometry state variables are updated till n+½,

$$[ \begin{matrix}{U}_{i , j}^{n + 1 / 2} \\ {V}_{i , j}^{n + 1 / 2}\end{matrix} ] = [ \begin{matrix}{U}_{i , j}^{n} \\ {V}_{i , j}^{n}\end{matrix} ] + \frac{{τ}_{i , j}^{n}}{{Δξ}_{i , j}} [ \begin{matrix}{u}_{i , j + 1 / 2}^{n + 1 / 2} - {u}_{i , j - 1 / 2}^{n + 1 / 2} \\ {v}_{i , j + 1 / 2}^{n + 1 / 2} - {v}_{i , j - 1 / 2}^{n + 1 / 2}\end{matrix} ] ∘ \qquad ( 50 )$$

In the same way, the λ-direction is parallel with the streamline. The Riemann problem along the λ-direction is called the Riemann problem along streamlines. Rewrite (7) only in λ-direction,

$$\frac{\partial f}{\partial τ} + \frac{\partial F ( f )}{\partial λ} = 0 , \\ f = \{ \begin{matrix}{f}_{L} , & λ < 0 , \\ {f}_{R} , & λ > 0 ,\end{matrix} \qquad ( 51 )$$

where all symbols have the same meaning with those in equation (23). The FIG. 5 shows the definition of the two-dimensional Riemann problem along streamline. similarly, the left and right states and left and right middle states all include the two velocity components, u and v, which both are across the shocks, expansion waves and middle waves expressed by the equations (10). The procedure to solve this problem is same as that shown in (24-50) but with replacement of u with v, sin θ with cos θ, tgθ with ctgθ. At the same time, the updated values can be found from the discretized equation (51),

$${f}_{i , j}^{n + 1} = {f}_{i , j}^{n + 1 / 2} - \frac{Δτ}{Δλ} [ F ( {f}_{i + 1 / 2 , j}^{n} ) - F ( {f}_{i - 1 / 2 , j}^{n} ) ] . \qquad ( 52 )$$

Finally, the stream-function geometry state variables are updated till n+1,

$$[ \begin{matrix}{U}_{i , j}^{n + 1} \\ {V}_{i , j}^{n + 1}\end{matrix} ] = [ \begin{matrix}{U}_{i , j}^{n + 1 / 2} \\ {V}_{i , j}^{n + 1 / 2}\end{matrix} ] + \frac{{Δτ}_{i , j}^{n}}{{Δλ}_{i , j}} [ \begin{matrix}{u}_{i + 1 / 2 , j}^{n + 1} - {u}_{i - 1 / 2 , j}^{n + 1} \\ {v}_{i + 1 / 2 , j}^{n + 1} - {v}_{i - 1 / 2 , j}^{n + 1}\end{matrix} ] . \qquad ( 53 )$$

### BRIEF DESCRIPTION OF THE DRAWINGS

FIG. 1 (a) is the physical model of the Riemann problem, where 1 present one-dimensional tube, 2 does diaphragm.

FIG. 1 (b) is the definition of the Riemann problem.

FIG. 2 (a) is the interfaces of the computing cell and the velocity vector.

FIG. 2 (b) is the velocity decomposition in the Riemann problem for the multi-dimensional computation.

FIG. 3 is the scheme of transformation from the Euler plane to the stream-function plane.

FIG. 4 is the definition of the Riemann problem across streamlines.

FIG. 5 is the definition of the Riemann problem along streamlines.

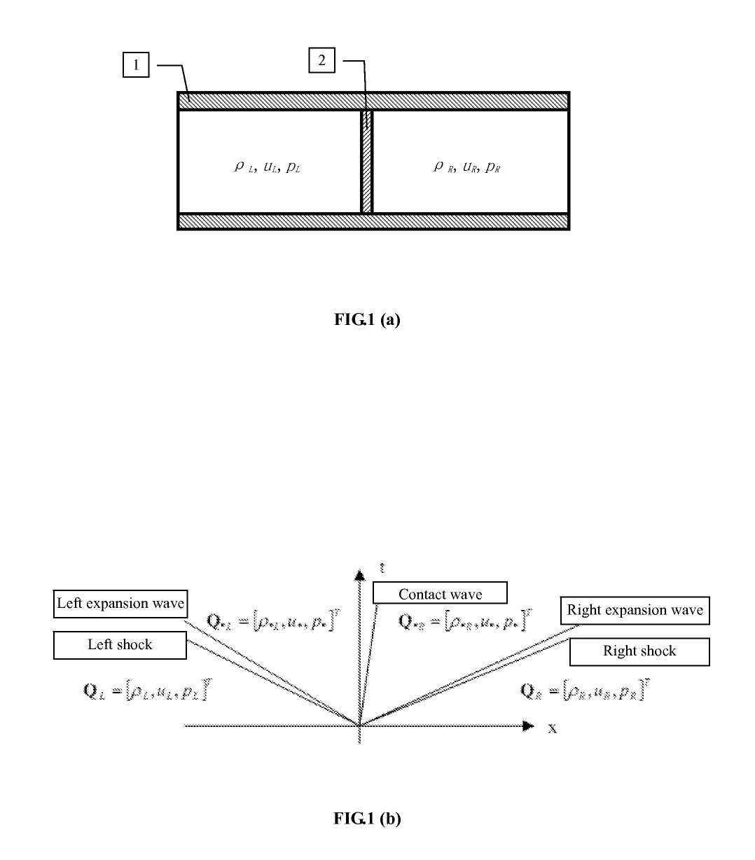

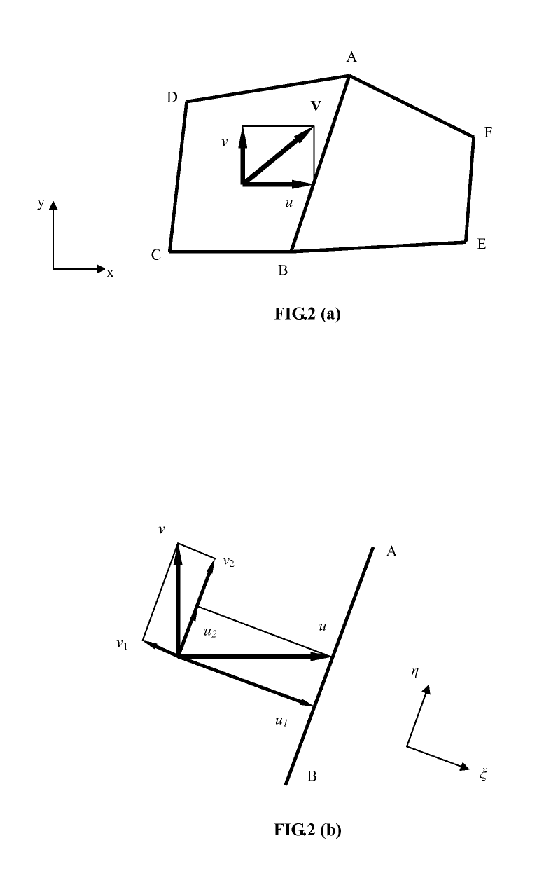

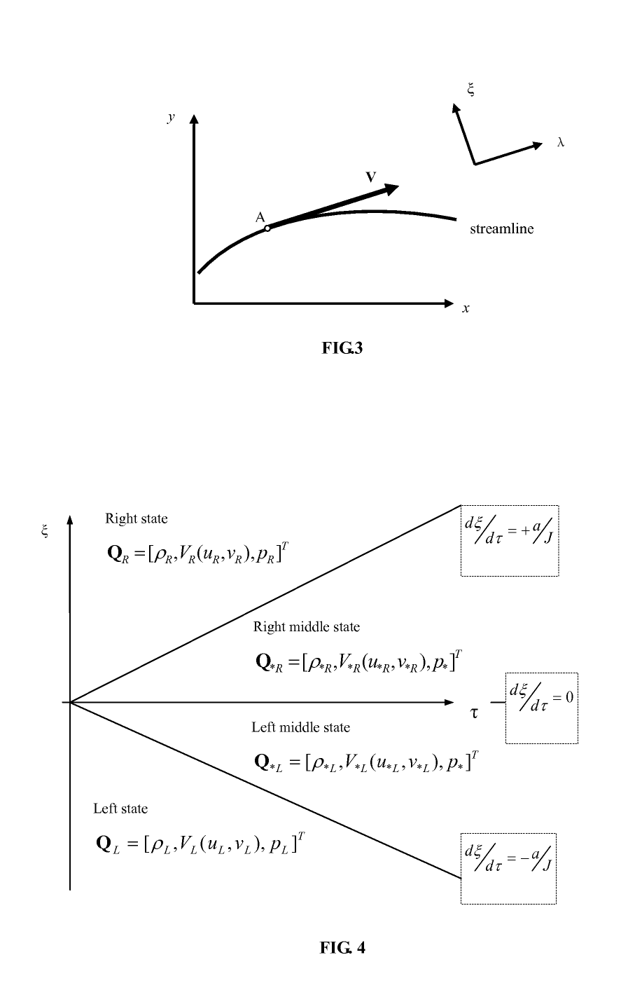

FIG. 6 is the solution by the invented method.
(a) Computing grid in the stream-function plane
(b) Computing grid in the Eulerian plane
(c) Streamlines by the invented method
(d) Streamlines by the Eulerian solution
(e) Comparison of the pressure distributions by the invented method and the exact solution on the bottom solid-wall boundary
(f) Computing grid built by the invented

### PREFERRED EMBODIMENT

According to the numerical method discussed above, a complete solution to the inviscid subsonic two-dimensional flow by using the Euler equations will be performed.

This example is about the subsonic flow passing through a two-dimensional parabolic divergent nozzle with length L and inlet height in Hᵢₙ, whose geometry is defined as the two parts of parabolic curves

$$H ( x ) = \{ \begin{matrix}- {ax}^{2} , & 0 \leq x < L / 2 ; \\ {a ( x - L )}^{2} - b , & L / 2 \leq x \leq L ,\end{matrix} \qquad ( 54 )$$

where Hᵢₙ=L/3, a=Hᵢₙ/2, b=Hᵢₙ/L. The Mach number of the inviscid flow at the nozzle inlet is Mᵢₙ=0.5. The flow is the pure subsonic flow. The Euler equations in stream-function formulation (7) will be solved by the numerical method presented in this invention. The finite volume method (FVM) is used to the spatial discretization. The second-order upwind MUSCL extrapolation with minmod limiter and the Strang dimensional-splitting of second-order accuracy in time are used. The computing parameters: CFL=0.48; totally 60×20 uniform cells in the stream-function plane. The computing results will be compared with those obtained from the publicly known JST method in the Eulerian plane and the exact solutions. In detail, the computations are taken as the following steps
(1) Initialization. The flow field variables Q⁰=[ρ⁰, u⁰, v⁰, p⁰]^{T} are known as the initial conditions as well as where U⁰, V⁰ take the values at the infinite and U⁰=0; V⁰=1. The superscript 0 means that the initial conditions of a flow problem are given at t=0 (τ=0) in x-y plane and λ-ξ plane. Subsequently, the conservation variables f⁰ are available. Then an appropriate rectangular λ-ξ coordinate mesh with uniform spatial step (Δλ, Δξ) is formed. The corresponding mesh in x-y plane is laid on according to

dx=cos θdλ;dy=sin θdλ (55)
(2) Calculate the time-step with CFL<0.5,

$$Δτ = CFL \cdot max ( \frac{Δλ}{\vert ( 1 - h ) \sqrt{{u}^{2} + {v}^{2}} + ( a / J ) \sqrt{{U}^{2} + {V}^{2}} \vert} , \frac{Δξ}{\vert a / J \vert} ) , \qquad ( 56 )$$

with

J=UT−VS, (57)

where S=sin θⁿ⁻¹, T=cos θⁿ⁻¹. θⁿ⁻¹ is from previous time-step.
(3) Solve the equation (51) along λ-direction by solving the two-dimensional Riemann problem along streamlines to update f_{i,j}ⁿ to f_{i,j}^{n+1/2}.
(4) Solve the equation (23) along ξ-direction by solving the two-dimensional Riemann problem across streamlines to update f_{i,j}^{n+1/2} to f_{i,j}ⁿ⁺¹.
(5) Update the stream-function geometry state variables.
(6) Find the physical primitive variable values [p, ρ, u, v]_{i,j}ⁿ⁺¹ at the new time step by decoding from the conservation variables f_{i,j}=[f₁, f₂, f₃, f₄]_{i,j}ⁿ⁺¹ to obtain

$$ρ = \frac{{f}_{1}}{J} ; \\ u = \frac{{f}_{2}}{{f}_{1}} ; \\ v = \frac{{f}_{3}}{{f}_{1}} ; \\ p = \frac{( γ - 1 )}{J} ( {f}_{4} - \frac{{f}_{2}^{2} + {f}_{3}^{2}}{2 {f}_{1}} ) . \qquad ( 58 )$$

Build grid. The grid points are given by

x_{i,j}ⁿ⁺¹=x_{i,j}ⁿ+1/2Δτ_{i,j}ⁿ(hu_{i,j}ⁿ+hu_{i,j}ⁿ⁺¹);y_{i,j}ⁿ⁺¹=y_{i,j}ⁿ+1/2Δτ_{i,j}ⁿ(hv_{i,j}ⁿ+hv_{i,j}ⁿ⁺¹). (59)
(8) Loop (2) until the conservation variables or primitive variables go to convergence.

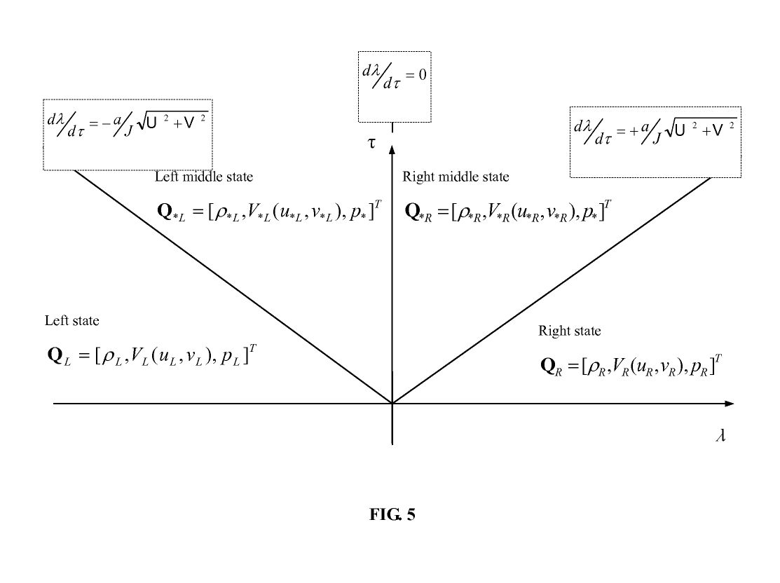

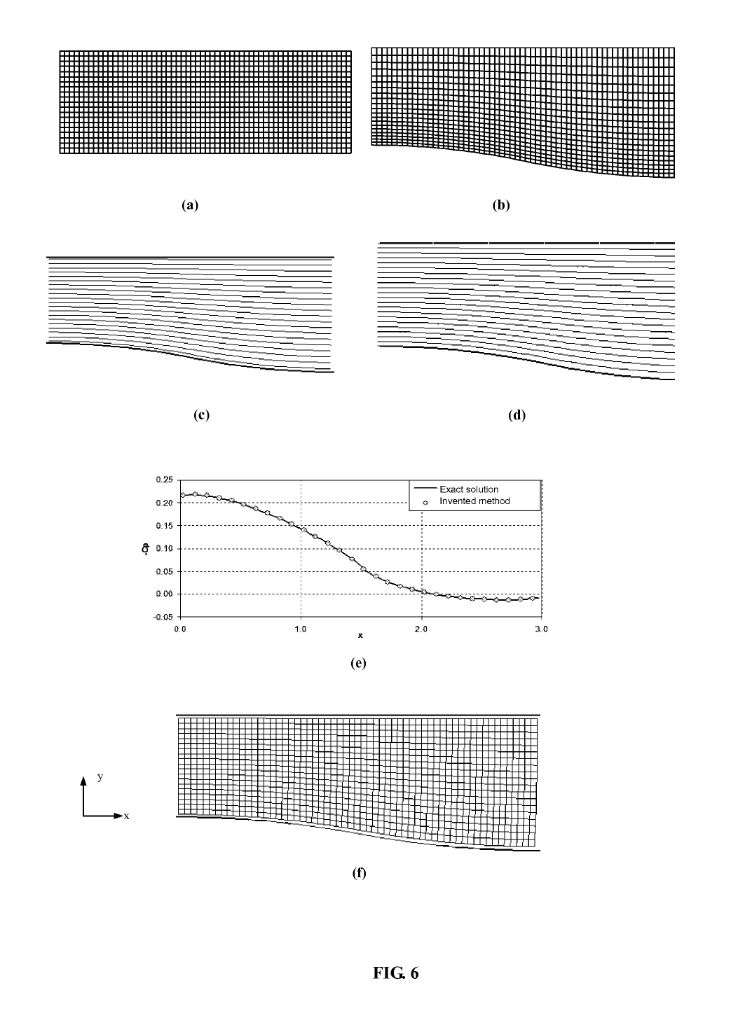

In the FIG. 6, The solution by the invented method starts from the rectangular computing grid with Lagrangian distance in λ-direction and stream function in direction in the FIG. 6 (a). The streamlines shown in the FIG. 6 (c) by the invented method agreed well with the solution by JST in the FIG. 4 (d). The pressure distributions on the solid-wall shown in the FIG. 4 (e) totally agreed with the exact solution. The computing grid used in the Eulerian coordinates in the FIG. 4(b) has little difference with that built by the invented method, where the lines along x-direction are streamlines and the lines along y-direction are not perpendicular to x-direction to preserve the length of the streamlines. It is worth to indicate that the final computing grid in the FIG. 4 (f) evolves from the initial computing grid in the FIG. 4 (a), and its lines are the streamlines themselves.

### REFERENCE

[1] Godunov, S. K.: A difference scheme for numerical computation discontinuous solution of hydrodynamic equations. Translated US Publ. Res. service, JPRS 7226, 1969.

What is claimed is:

1. A computer implemented numerical method for solving the two-dimensional Riemann problem to simulate inviscid subsonic flows, comprises following steps:
(1) transforming the two-dimensional Euler equations in the Eulerian plane, using a transforming matrix with Jacobian
$$J = [ \begin{matrix}1 & 0 & 0 \\ u & cos θ & U \\ v & sin θ & V\end{matrix} ] ,$$
into a stream-function formulation in a stream-function plane expressed by a time τ-direction (direction), a stream-function ξ-direction and a particle traveling distance λ-direction, so-called two-dimensional Euler equations in the stream-function formulation in the stream-function plane formally are
$$\frac{\partial {f}_{s}}{\partial τ} + \frac{\partial {F}_{s}}{\partial λ} + \frac{\partial {G}_{s}}{\partial ξ} = 0 ,$$
where f_{S} is conservation variables vector; F_{S} and G_{S} are respectively convection flux along the λ-direction and ξ-direction in the stream-function plane, and,
$${f}_{s} = [ \begin{matrix}ρ J \\ ρ Ju \\ ρ Ju \\ ρ JE \\ U \\ V\end{matrix} ] , \\ {F}_{s} = [ \begin{matrix}0 \\ V p \\ - U p \\ 0 \\ 0 \\ 0\end{matrix} ] , \\ {G}_{s} = [ \begin{matrix}0 \\ - p sin θ \\ p cos θ \\ 0 \\ - u \\ - v\end{matrix} ] , \\ θ = {tg}^{- 1} ( \frac{v}{u} ) ,$$
where ρ, p and E are respectively density, pressure and total energy; u, v are two velocity components in the Cartesian coordinator system; U, V are two stream-function geometry state variables;
(2) building a computing grid;
(3) solving a two-dimensional Riemann problem on every interfaces of computing cells formed by the computing grid when numerically solving the time-dependent two-dimensional Euler equations in the stream-function formulation in the stream-function plane.

2. The method of claim 1, wherein said computing grid is a rectangular grid constructed with the λ-direction and ξ-direction in the stream-function plane.

3. The method of claim 1, wherein said solving the time-dependent two-dimensional Euler equations in the stream-function formulation in the stream-function plane needs to literately update the conservation variable f_{S} along the τ-direction until obtaining a steady f_{S}.

4. The method of claim 1, wherein said solving a two-dimensional Riemann problem on every interfaces of computing cells formed by the computing grid when numerically solving the time-dependent two-dimensional Euler equations in the stream-function formulation in the stream-function plane needs solving a Riemann problem across streamlines and a Riemann problem along streamline to calculate the convection flux on the interfaces of the computing cells.

5. The method of claim 4, wherein said Riemann problem across streamlines and Riemann problem along streamline have the following properties: there existing a left state and a right state expressed by shocks or expansion waves on two sides of the computing cells; between the two states there existing a middle state, which is divided as a left middle state and a right middle state.

6. The method of claim 4, wherein said solving the Riemann problem across streamlines and the Riemann problem along streamline comprises following steps:
(1) Connecting the left and right states to the middle state by integrating along characteristic equations of the Euler equations in stream-function formulation, where the left, right and middle states are given in claim 5;
(2) Recovering velocity magnitude in the middle state;
(3) Solving a combination function f(u, v) to find flow angle in the middle state;
(4) Finding the velocity component in the star state.

7. The method of claim 6, wherein said recovering the velocity magnitude in the middle state, is implemented according to the Rankine-Hugoniot relations across shocks and the Enthalpy constants across expansion waves.

8. The method of claim 6, wherein said combination function f(u, v) is expressed as
$$f ( u , v ) = \frac{1}{2} \frac{v \sqrt{{u}^{2} + {v}^{2}}}{u} + \frac{1}{2} u ln ( v + \sqrt{{u}^{2} + {v}^{2}} ) .$$
